(19) United States
(12) Patent Application Publication
(10) Pub. No.: US 2011/0056886 A1
(43) Pub. Date: Mar. 10, 2011

(54) Oil spill recovery process

(76) Inventor: Nicholas De Luca, Washington, DC (US)

(21) Appl. No.: 12/803,414

(22) Filed: Jun. 25, 2010

Related U.S. Application Data
(63) Continuation-in-part of application No. 12/459,055, filed on Jun. 26, 2009.

(51) Int. Cl. C02F 1/40; E02B 15/04

(52) U.S. Cl. 210/671

(57) ABSTRACT

A process for collecting spilled oil, comprises deploying a mechanically expanded sheet of foam so that it contacts spilled oil, the mechanically expanded sheet of foam comprising an oleophilic composition, absorbing oil into the expanded sheet of foam to produce an oil-containing expanded sheet of foam so that the expanded sheet of foam contains collected oil, squeezing the oil-containing expanded sheet of foam so that absorbed oil in the oil-containing expanded sheet of foam is released from the expanded sheet of foam; and collecting the oil released from the oil-containing expanded sheet of foam.

### CROSS-REFERENCE TO RELATED APPLICATION

This application is a continuation-in-part of U.S. Ser. No. 12/459,055, entitled “Expandable Foam Sheet that Locks in Expanded Configuration”, to N. P. De Luca et al, filed 26 Jun. 2009, which application is hereby incorporated, in its entirety, by reference thereto.

### FIELD AND BACKGROUND

The present invention is in the field of oil recovery, i.e., a method for recovering oil from an oil spill, particularly for recovering oil spilled into water, including salt water or fresh water. This invention utilizes an oil-absorbent article for pickup and recovery of oil. The process is particularly useful for the removal of oil slicks or spills from a body of water, particularly the sea.

The need for recovery of oil spills has been known to exist for many years. Various oil-absorbent articles and methods have been disclosed, including partially or completely surrounding oil spilled onto or into water, using booms and pumps to collect and pump the spilled oil. Absorbent materials have also been used to recover spilled oil. Such absorbent materials have included sand, kiselgiuhr, diatomaceous earth, peat fibers, sawdust, straw, and foam, particularly foam made from polyolefins. However, the need remains for an efficient process of oil recovery from an oil spill, particularly an oil spill in the sea.

### SUMMARY

The process of the invention utilizes a mechanically expanded foam sheet to absorb and recover spilled oil. A first aspect of the invention is a process for collecting spilled oil, comprising: (A) deploying a mechanically expanded sheet of foam so that it contacts spilled oil, the mechanically expanded sheet of foam comprising an oleophilic composition; (B) absorbing oil into the expanded sheet of foam to produce an oil-containing expanded sheet of foam so that the expanded sheet of foam contains collected oil; (C) squeezing the oil-containing expanded sheet of foam so that absorbed oil in the oil-containing expanded sheet of foam is released from the expanded sheet of foam; and (D) collecting the oil released from the oil-containing expanded sheet of foam.

In an embodiment, the process further comprising re-deploying the oil-containing expanded sheet of foam so that it contacts spilled oil for a second time and again absorbs oil thereinto, followed by squeezing the oil-containing expanded sheet of foam so that the absorbed oil is released, and again collecting the oil released from the oil-containing expanded sheet of foam.

In another embodiment, the process comprises re-deploying the oil-containing expanded sheet of foam so that it contacts spilled oil for a third time and again absorbs oil thereinto, followed by squeezing the oil-containing expanded sheet of foam so that the absorbed oil is released, and again collecting the oil released from the oil-containing expanded sheet of foam. Additional embodiments repeat the deployment, absorbing, squeezing, and collecting for additional cycles, including at least 10, 20, 40, 80, or even 100 or more cycles, using the same mechanically expanded sheet of foam.

In an embodiment, the spilled oil is present as an oil-in-water mixture, and the expanded sheet of foam is deployed into the oil-in-water mixture where the expanded sheet of foam contacts both water and spilled oil. The water can be salt water, or fresh water.

In an embodiment, the expanded foam sheet absorbs oil in an amount of at least 10 times its own weight.

In an embodiment, the expanded foam sheet absorbs oil in an amount of at least 20 times its own weight.

In an embodiment, the expanded foam sheet is an expanded foam sheet in accordance with U.S. Ser. No. 12/459,055, which has been incorporated by reference in its entirety.

In an embodiment, the expanded foam sheet is made by slitting a foam sheet using a slit pattern as disclosed in U.S. Pat. No. 3,655,501, to Tesch, which is hereby incorporated, in its entirety, by reference thereto.

In another embodiment, the expanded foam sheet is in accordance with U.S. Pat. No. 5,705,252, to Lea et al, which is hereby incorporated in its entirety, by reference thereto.

In an embodiment, the expanded foam sheet is prepared from an unexpanded, mechanically-expanded foam sheet comprising a plurality of discrete slits therein, the expandable foam sheet being mechanically expandable from an unexpanded foam sheet configuration to an expanded foam sheet configuration, the expandable foam sheet having a density of from 14 g/liter to 48 g/liter in the unexpanded configuration and a thickness of from 6 mm to 50 mm, the slits being of a size and shape and arrangement so that the expanded foam sheet locks into the expanded configuration by exhibiting a pressure-to-close of at least 5 gm/cm², with each of the slits providing only a single free volume in the expanded foam sheet.

In an embodiment, the expanded foam sheet is prepared from an unexpanded, mechanically-expandable foam sheet, wherein: (A) the unexpanded foam sheet configuration comprises a plurality of transverse stabilization walls X, each stabilization wall comprising a plurality of cavity wells along a first side thereof, and a plurality of cavity wells along a second side thereof, with the cavity wells being bounded on a first side by a first finger extending from and integral with the stabilization wall and being bounded on a second side by a second finger extending from and integral with the stabilization wall, the fingers extending between adjacent cavity wells on the same side of the stabilization wall, the cavity wells containing at least a portion of a finger from an adjacent stabilization wall extending thereinto, with the finger within the cavity well being hingedly attached to an associated pair of expansion-and-locking arms, including being hingedly attached to a first end of a first expansion-and-locking arm within said cavity well and hingedly attached to a first end of a second expansion-and-locking arm also within said cavity well, with the first expansion-and-locking arm having a second end that is hingedly attached to the first finger bounding the first side of the cavity well, and the second expansion-and-locking arm having a second end that is hingedly attached to the second finger bounding the second side of the cavity well; and (B) the expanded foam sheet configuration comprises the plurality of transverse stabilization walls X and a plurality of transverse locking arm walls Y, with the plurality of transverse stabilization walls X and the plurality of transverse locking arm walls Y alternating in X-Y-X-Y arrangement, with a single transverse stabilization wall being connected to a single transverse locking arm wall by a plurality of the fingers extending from and integral with the transverse stabilization wall, and with the locking arm walls comprising a plurality of pairs of first and second expansion-and-locking arms in inverted position, with said first and second expansion-and-locking arms in inverted position having emerged from the cavity well of the unexpanded foam sheet during expansion of the foam sheet so that said first and second expansion-and-locking arms are locked in the inverted position, with the plurality of cavity wells and the plurality of associated pairs of expansion-and-locking arms locked in inverted position surrounding a corresponding number of discrete free volumes within the expanded foam sheet. In an embodiment, the unexpanded, mechanically-expandable foam sheet comprises expansion-and-locking arms of non-uniform width, wider in a middle region than at end regions at which the expansion-and-locking arms are hingedly attached to the fingers. In an embodiment, the unexpanded, mechanically-expandable foam sheet comprises expansion-and-locking arms of substantially uniform width. In an embodiment, each cavity well has a centrally-positioned finger therein.

In an embodiment, the mechanically-expanded foam sheet comprises at least one member selected from polyolefin, polyurethane, rubber, silicone resin, ethylene/unsaturated acrylate copolymer, ethylene/acrylic acid copolymer, ethylene/methacrylic acid copolymer, ionomer resin, styrene/butadiene copolymer, styrene/butadiene/styrene random and block copolymer, styrene/isoprene/styrene random and block copolymer, and styrene/ethylene/butylene copolymer.

In an embodiment, the mechanically-expanded foam sheet comprises at least one member selected from ethylene homopolymer, ethylene/alpha-olefin copolymer, propylene homopolymer, propylene/alpha-olefin copolymer, ethylene/methyl acrylate copolymer, ethylene/ethyl acrylate copolymer, ethylene/butyl acrylate copolymer, and polyurethane.

In an embodiment, the mechanically-expanded foam sheet exhibits a percent free volume of from 40 percent to 70 percent.

In an embodiment, the foam sheet has a density of from 0.5 to 2 pounds per cubic foot while the foam sheet is in a mechanically unexpanded configuration, and the foam sheet has a thickness of from 0.25 inch to 1.5 inches.

In an embodiment, the foam sheet has a density of from 1 to 1.5 pounds per cubic foot while the foam sheet is in a mechanically unexpanded configuration, and the foam sheet has a thickness of from 0.25 inch to 1 inch.

In an embodiment, the foam sheet has a density of from 1.1 to 1.3 pounds per cubic foot while the foam sheet is in a mechanically unexpanded configuration, and the foam sheet has a thickness of from 0.5 to 0.75 inch.

In an embodiment, the expandable foam sheet is in an expanded configuration and is adhered to a non-expandable foam sheet or film.

In an embodiment, a plurality of expanded foam sheets are laminated to one another.

In an embodiment, a plurality of expanded foam sheets are laminated to one another, and the plurality of expanded foam sheets laminated to one another are laminated to a non-expandable foam sheet.

In an embodiment, a length of sheet of expanded foam is laid on an oil-and-water mixture and a vessel takes in the sheet of expanded foam after it has absorbed oil, with the vessel having a mechanism to remove oil from the oil-laden sheet of expanded foam by squeezing (i.e., compressing) the oil-laden sheet of expanded foam, with the vessel continuously taking in the expanded oil-laden sheet of expanded foam, continuously squeezing oil from the oil-laden sheet of expanded foam, and continuously re-deploying the sheet of expanded foam after oil has been squeezed out of the oil-laden sheet of expanded foam.

### BRIEF DESCRIPTION OF THE DRAWINGS

FIG. 1 is a schematic view of a preferred expandable slit foam sheet, in its unexpanded configuration.

FIG. 2 is a schematic view of the preferred foam sheet of FIG. 1, locked in its expanded configuration.

### DETAILED DESCRIPTION AND EXAMPLES

The sheet of expanded foam comprises a hydrophilic composition in order to attract and absorb oleophilic compositions (e.g., spilled oil) into and onto the expanded foam sheet, and in order to minimize water absorption by the foam sheet. While olefinic polymers such as polyethylene, propropylene, etc., and various copolymers thereof, are suitable oleophilic compositions, additional oleophilic compositions can be added to the foam.

Preferred polyethylene resins exhibit a density between about 0.88 and about 0.95 g/cc, preferably between about 0.91 and about 0.94 g/cc, and a melt index of from about 0.5 and about 100 g/10 min, preferably from about 0.5 to about 10 g/10 min, and more preferably from about 1 to about 4 g/10 min, using ASTM 1238 using a 2160 gram weight and 190° C. temperature.

Ethylene/alkyl acrylate copolymers can be used in the expanded foam sheet. Such copolymers are preferably copolymers of ethylene and methyl acrylate or ethyl acrylate, or mixtures thereof. Preferably, such copolymers have an alkyl acrylate content of from about 3% to about 45%, based on total copolymer weight. Preferably the alkyl acrylate content is from about 15 wt. % to about 25 wt, %, and preferably have a melt index of from about 0.5 to about 4 g/10 min.

The expanded foam sheet may contain polymer blends. One blend may comprise from about 10 wt % to about 80 wt. % of a copolymer or blend of copolymers, and between about 80 wt % to about 20 wt % polyethylene or polypropylene. Another blend may comprise from about 40 wt. % to about 60 wt % of a copolymer, and most preferred from about 50 wt. % to about 60 wt. % copolymer, with the balance being polyethylene and/or polypropylene.

The expanded foam sheet may comprise crosslinked polymer. One method of cross-linking employs an organic peroxide. Examples of organic peroxides include dicumylperoxide, 2,5-dimethyl-2,5-di(t-butylperoxy) hexane, 1,1-bis(t-butylperoxy)-3,3,5-trimethylcyclohexane, 1,1-di-(t-butylperoxy)cyclohexane, 2,2′-bis(t-butylperoxy)-diisopropylbenzene, 4,4′-bis(t-butylperoxy)butylvalerate, t-butylperbenzoate, t-butylperterephthalate, and t-buytyl peroxide. Most preferably, the peroxide cross-linking agent is dicumylperoxide or 2,2′-bis(t-butylperoxy) diisopropylbenzene.

The cross-linked polymer can optionally be grated. Grafting involves attaching monomer or polymer to the original polymer resin chains. The grafting may be generally accomplished by forming active grafting sites on the original polymer chains in the presence of monomers that can be generated, for example, by free radicals or anions. A graft can include other monomers, such as di and tri-allyl cyanurates and isocyanurates, alkyl di- and tri-acrylates and methacrylates, zinc dimethacrylates and dicralyates, styrenes, divinylbenzene, vinyl silanes with at least two hydrolysable groups, and butadiene. Silane-grated polymer blends can be cross-linked by reaction with moisture. The polymer blend may also be grated with maleic anhydride to modify the absorption properties.

A biodegradable additive can be included in the formulation. A suitable biodegradable additive is available from Sierra Resins in SR2003. This additive has a biodegradation initiator that aides in the creation of enzymes that can digest the polymer. Other such additives include Bio-Tec's Ecopure.

Other additives, alone or in combination, can be added to the foam compositions including antioxidants (e.g., hindered phenolics such as Irganox 1010, phosphates such as Irgafos 168, or polymerized trimethyl-dihydroquinoline such a sAgerite AK, Resin D or Flectol H), ultra-violet stablizers, thermal stablizers, antistatic components, flame retardants, pigments or colorants, and other processing aids.

Production of the foam sheet can be carried out in a manner as known to those of skill in the art.

The squeezing of the oil-laden expanded sheet of foam can be carried out by continuously compressing the oil-laden expanded sheet between one or more pairs of rotating nip rollers, or by oscillating presses in combination with discontinuous forwarding of the oil-laden expanded sheet of foam thereinto.

Tables 1 (part i), Table 1 (part ii) and Table I (part iii), set forth below, describe characteristics of various foam sheets and their respective uptake of oil from an oil-in-water mixture. As is readily apparent from the data provided in Table 1 (i-iii), the expanded polyethylene sheets were by far more effective in absorbing oil compared with unexpanded foam sheet.

TABLE 1
(part i)

| | Sample | Sample | Sample | Effective | 1st Use Oil | 1st Use Grams |
|---|---|---|---|---|---|---|
| | Weight | Flat Area | Thickness | Density | Saturation | Oil/Grams |
| Material Type | (g) | (in²) | (in) | g/in³ | Level (g) | Material |
| polypropylene sheet | 19.92 | 80.0 | 0.125 | 1.99 | 153.74 | 7.72 |
| ½″ thick, | 5.69 | 80.0 | 0.5 | 0.14 | 193.6 | 34.02 |
| mechanically- | | | | | | |
| expanded | | | | | | |
| polyethylene foam | | | | | | |
| sheet (1.2 lb/cu. ft | | | | | | |
| before expansion) | | | | | | |
| 3″ Roll Boom | 64 | 108.4 | not | 0.91 | 326 | 5.09 |
| | | | applicable | | | |
| ½″ thick, | 12 | 80.0 | 0.5 | 0.30 | 34 | 2.83 |
| mechanically- | | | | | | |
| unexpandable | | | | | | |
| polyethylene foam | | | | | | |
| sheet (1.2 lb/cu. ft.) | | | | | | |
| ¾″ thick, 1.2 lb/cu ft | 10 | 80.0 | 0.75 | 0.17 | 304 | 30.40 |
| before expansion | | | | | | |
| mechanically- | | | | | | |
| expandable | | | | | | |
| polyethylene foam | | | | | | |
| sheet, 8″ × 10″ | | | | | | |
| ¾″ thick, 2.2 lb/cu ft | 16 | 80.0 | 0.75 | 0.27 | 240 | 15.00 |
| before expansion | | | | | | |
| mechanically- | | | | | | |
| expandable | | | | | | |
| polyethylene foam | | | | | | |
| sheet, 8″ × 10″ | | | | | | |

(part ii)

| | | Sample | Oil | | Sample |
|---|---|---|---|---|---|
| | | Weight | Saturation | 2nd Use | Weight |
| | Saturation | After 1st | Level After | GramsOil/ | After 2nd |
| Material Type | Time | Sqeeze(g) | 1st Squeeze(g) | GramsMaterial | Sqeeze(g) |
| Polypropylene sheet | <10 min | 78 | 166 | 8.33 | 72 |
| ½″ thick, | <10 min | 26 | 170 | 29.88 | 28 |
| mechanically- | | | | | |
| expanded | | | | | |
| polyethylene foam | | | | | |
| sheet (1.2 lb/cu. ft | | | | | |
| before expansion) | | | | | |
| 3″ Roll Boom | 10 min | 218 | 172 | 2.69 | 236 |
| | test | | | | |
| ½″ thick, | 10 min | 12 | 34 | 2.83 | 12 |
| mechanically- | test | | | | |
| unexpandable | | | | | |
| polyethylene foam | | | | | |
| sheet (1.2 lb/cu. ft.) | | | | | |
| ¾″ thick, 1.2 lb/cu ft | <10 min | 52 | 252 | 25.20 | 50 |
| before expansion | | | | | |
| mechanically- | | | | | |
| expandable | | | | | |
| polyethylene foam | | | | | |
| sheet, 8″ × 10″ | | | | | |
| ¾″ thick, 2.2 lb/cu ft | <10 min | 56 | 184 | 11.50 | 56 |
| before expansion | | | | | |
| mechanically- | | | | | |
| expandable | | | | | |
| polyethylene foam | | | | | |
| sheet, 8″ × 10″ | | | | | |

(part iii)

| | 1st Use | | Sample | Oil | | Sample |
|---|---|---|---|---|---|---|
| | Grams | | Weight | Saturation | 2nd Use | Weight |
| | Oil/Grams | Saturation | After 1st | Level After | GramsOil/ | After 2nd |
| Material Type | Material | Time | Sqeeze(g) | 1st Squeeze(g) | GramsMaterial | Sqeeze(g) |
| polypropylene | 7.72 | <10 min | 78 | 166 | 8.33 | 72 |
| sheet | | | | | | |
| ½″ thick, | 34.02 | <10 min | 26 | 170 | 29.88 | 28 |
| mechanically- | | | | | | |
| expanded | | | | | | |
| polyethylene | | | | | | |
| foam sheet | | | | | | |
| (1.2 lb/cu. ft | | | | | | |
| before | | | | | | |
| expansion) | | | | | | |
| 3″ Roll Boom | 5.09 | 10 min | 218 | 172 | 2.69 | 236 |
| | | test | | | | |
| ½″ thick, | 2.83 | 10 min | 12 | 34 | 2.83 | 12 |
| mechanically- | | test | | | | |
| unexpandable | | | | | | |
| polyethylene | | | | | | |
| foam sheet | | | | | | |
| (1.2 lb/cu.ft.) | | | | | | |
| ¾″ thick, 1.2 | 30.40 | <10 min | 52 | 252 | 25.20 | 50 |
| lb/cu ft | | | | | | |
| before | | | | | | |
| expansion | | | | | | |
| mechanically- | | | | | | |
| expandable | | | | | | |
| polyethylene | | | | | | |
| foam sheet, | | | | | | |
| 8″ × 10″ | | | | | | |
| ¾″ thick, 2.2 | 15.00 | <10 min | 56 | 184 | 11.50 | 56 |
| lb/cu ft | | | | | | |
| before | | | | | | |
| expansion | | | | | | |
| mechanically- | | | | | | |
| expandable | | | | | | |
| polyethylene | | | | | | |
| foam sheet, | | | | | | |
| 8″ × 10″ | | | | | | |

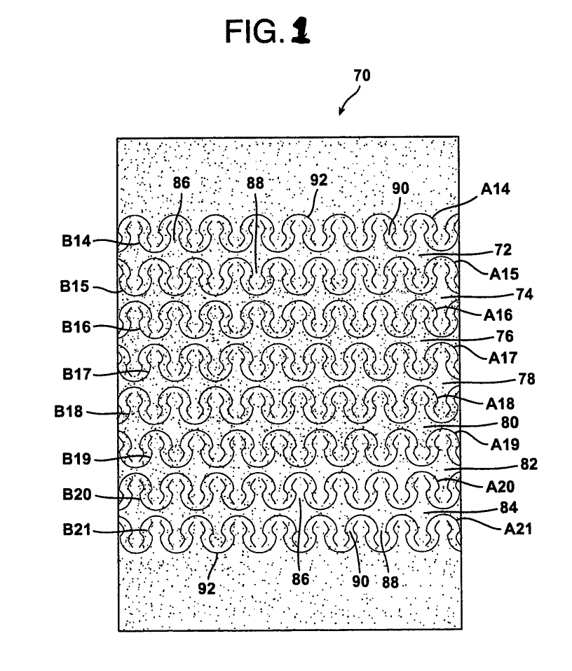

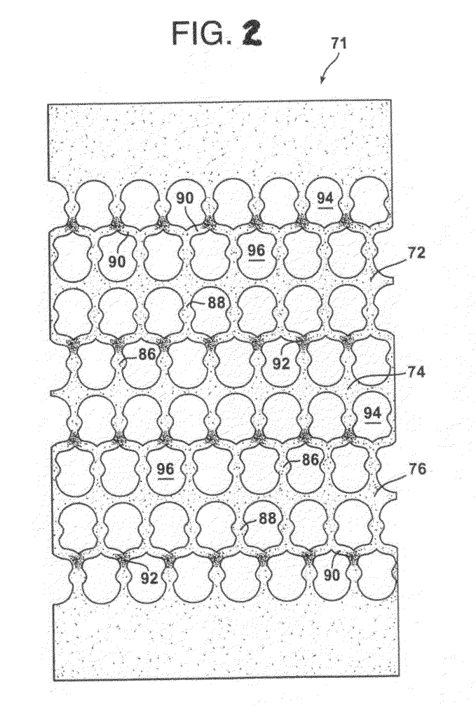

The expanded foam sheet exhibited an appearance as illustrated in FIG. 1, which sheet of mechanically expanded foam was slit in accordance with the slit pattern illustrated in FIG. 2. FIGS. 1 and 2 illustrate expandable foam sheet 70 and expanded foam sheet 71. This embodiment is herein referred to as the “B5” embodiment. FIG. 1 illustrates expandable foam sheet 70 in unexpanded configuration. Unexpanded, expandable foam sheet 70 is illustrated with eight transverse rows of rows of Type A slits, i.e., rows of slits A14 through A21, and eight transverse rows of Type B slits, i.e., rows of slits B14 through B21. Again, each individual Type A row of slits A14 through A21 is coupled and interlocked with a respective row of Type B slits B14 through B21, with the rows of Type A and Type B slits alternating in A-B-A-B arrangement, more particularly alternating in a coupled —A&B—A&B—A&B—etc. arrangement. Unexpanded, expandable foam sheet 70 also has stabilization walls 72, 74, 76, 78, 80, 82, and 84, each of which has a plurality of fingers 86 extending from and integral with a first side thereof, and a plurality of fingers 88 extending from and integral with a second side thereof. The Type A slits of rows of slits A14-A21 each have an overall curvilinear shape with an overall concavity facing and interlocking with respective coupled row of Type B slits B14-B21. Likewise, Type B slits of rows of slits B14-B21 each have an overall curvilinear shape with an overall concavity facing and interlocking with respective coupled row of Type A slits A14-A21.

In the B5 embodiment the arrangement of the coupled rows of slits with their concavities facing one another provides cavity wells with one centrally-positioned finger 86 or 88 within each cavity well. The foam between the coupled rows of slits A14-A21 and respectively B14-B21 provides expansion and locking arms 90, with the foam between the coupled rows of slits further including hinged connections 92 of each end of expansion-and-locking arms 90 to fingers 86 and 88 which extend from stabilization walls 72, 74, 76, 78, 80, 82, and 84.

FIG. 2 illustrates a portion of the B5 sheet of FIG. 1, in its expanded configuration as expanded foam sheet 71. Expanded foam sheet 71 includes Type A free volumes 94 and Type B free volumes 96. A locking arm wall is present between stabilization walls 72 and 74, and a locking arm wall is also present between stabilization wall 74 and 76. Hinged connections 92 connect expansion and locking arm walls 90 to the ends of fingers 86 and 88.

More particularly, the details set forth in Tables 2 (i) and 2 (ii), below, pertain to the expanded foam sheets of Table 1 (i-iii).

TABLE 2
(i)

| | | | | | Force- | Pressure- | Repeat | Rep. s. | cell | Cell | | | |
|---|---|---|---|---|---|---|---|---|---|---|---|---|---|
| | | | Sheet | | to- | to- | Finger- | wall-to- | area - | Area - | Hinge | Hinge | Hinge |
| Row | Sample | Density | Thickness | | Close | Close | to- | st. wall - | closed | open | distance | Separation | Angle |
| No. | Identity | (lb/ft³) | (in) | Scale | (gms) | (g/cm²) | Finger (in) | closed (in) | (in²) | (in²) | (in) | (in) | (deg) |
| 94 | B5 | 1.2 | 0.5 | 0.5 | 20 | 2.0 | 0.34 | 0.35 | 0.12 | 0.21 | 0.05 | 0.06 | 37 |
| 95 | B5 | 1.2 | .75 | 0.5 | 90 | 5.9 | 0.50 | 0.53 | 0.26 | 0.23 | 0.07 | 0.08 | 37 |

(ii)

| | | | stab. | | | | |
|---|---|---|---|---|---|---|---|
| | | Arm | wall | Neck | Start | Expanded | |
| Row | Sample | thickness | thck. | Height | Length | Length | |
| No. | Identity | (in) | (in) | (in) | (in) | (in) | Comment |
| 94 | B5 | 0.06 | 0.05 | 0.21 | 2 | 3.63 | Flaky cut, tore |
| 95 | B5 | 0.08 | 0.07 | 0.31 | 3 | 4.00 | Cut thru some |

What is claimed is:

1. A process for collecting spilled oil, comprising:
(A) deploying a mechanically expanded sheet of foam so that it contacts spilled oil, the mechanically expanded sheet of foam comprising an oleophilic composition;
(B) absorbing oil into the expanded sheet of foam to produce an oil-containing expanded sheet of foam so that the expanded sheet of foam contains collected oil;
(C) squeezing the oil-containing expanded sheet of foam so that absorbed oil in the oil-containing expanded sheet of foam is released from the expanded sheet of foam; and
(D) collecting the oil released from the oil-containing expanded sheet of foam.

2. The process according to claim 1, further comprising re-deploying the oil-containing expanded sheet of foam so that it contacts spilled oil for a second time and again absorbs oil thereinto, followed by squeezing the oil-containing expanded sheet of foam so that the absorbed oil is released, and again collecting the oil released from the oil-containing expanded sheet of foam.

3. The process according to claim 3, further comprising re-deploying the oil-containing expanded sheet of foam so that it contacts spilled oil for a third time and again absorbs oil thereinto, followed by squeezing the oil-containing expanded sheet of foam so that the absorbed oil is released, and again collecting the oil released from the oil-containing expanded sheet of foam.

4. The process according to claim 3, further comprising re-deploying the oil-containing expanded sheet of foam so that it contacts spilled oil for at least 10 cycles, each time absorbing oil thereinto, followed by squeezing the oil-containing expanded sheet of foam so that the absorbed oil is released, and again collecting the oil released from the oil-containing expanded sheet of foam.

5. The process according to claim 3, further comprising re-deploying the oil-containing expanded sheet of foam so that it contacts spilled oil for at least 30 cycles, each time absorbing oil thereinto, followed by squeezing the oil-containing expanded sheet of foam so that the absorbed oil is released, followed by again collecting the oil released from the oil-containing expanded sheet of foam.

6. The process according to claim 1, wherein the oil is spilled into water and the expanded sheet of foam is deployed into an oil-in-water mixture and the expanded foam sheet contacts both water and spilled oil.

7. The process according to claim 6, wherein the water is salt water.

8. The process according to claim 6, wherein the water is fresh water.

9. The process according to claim 1, wherein the expanded foam sheet absorbs oil in an amount of at least 10 times its own weight.

10. The process according to claim 1, wherein the expanded foam sheet absorbs oil in an amount of at least 20 times its own weight.

11. The process according to claim 1, wherein the expanded foam sheet is prepared from an unexpanded, mechanically-expanded foam sheet comprising a plurality of discrete slits therein, the expandable foam sheet being mechanically expandable from an unexpanded foam sheet configuration to an expanded foam sheet configuration, the expandable foam sheet having a density of from 14 g/liter to 48 g/liter in the unexpanded configuration and a thickness of from 6 mm to 50 mm, the slits being of a size and shape and arrangement so that the expanded foam sheet locks into the expanded configuration by exhibiting a pressure-to-close of at least 5 gm/cm², with each of the slits providing only a single free volume in the expanded foam sheet.

12. The process according to claim 11, wherein the expanded foam sheet is prepared from an unexpanded, mechanically-expandable foam sheet, wherein:
(A) the unexpanded foam sheet configuration comprises a plurality of transverse stabilization walls X, each stabilization wall comprising a plurality of cavity wells along a first side thereof, and a plurality of cavity wells along a second side thereof, with the cavity wells being bounded on a first side by a first finger extending from and integral with the stabilization wall and being bounded on a second side by a second finger extending from and integral with the stabilization wall, the fingers extending between adjacent cavity wells on the same side of the stabilization wall, the cavity wells containing at least a portion of a finger from an adjacent stabilization wall extending thereinto, with the finger within the cavity well being hingedly attached to an associated pair of expansion-and-locking arms, including being hingedly attached to a first end of a first expansion-and-locking arm within said cavity well and hingedly attached to a first end of a second expansion-and-locking arm also within said cavity well, with the first expansion-and-locking arm having a second end that is hingedly attached to the first finger bounding the first side of the cavity well, and the second expansion-and-locking arm having a second end that is hingedly attached to the second finger bounding the second side of the cavity well; and
(B) the expanded foam sheet configuration comprises the plurality of transverse stabilization walls X and a plurality of transverse locking arm walls Y, with the plurality of transverse stabilization walls X and the plurality of transverse locking arm walls Y alternating in X-Y-X-Y arrangement, with a single transverse stabilization wall being connected to a single transverse locking arm wall by a plurality of the fingers extending from and integral with the transverse stabilization wall, and with the locking arm walls comprising a plurality of pairs of first and second expansion-and-locking arms in inverted position, with said first and second expansion-and-locking arms in inverted position having emerged from the cavity well of the unexpanded foam sheet during expansion of the foam sheet so that said first and second expansion-and-locking arms are locked in the inverted position, with the plurality of cavity wells and the plurality of associated pairs of expansion-and-locking arms locked in inverted position surrounding a corresponding number of discrete free volumes within the expanded foam sheet.

13. The process according to claim 12, wherein the unexpanded, mechanically-expandable foam sheet comprises expansion-and-locking arms of non-uniform width, wider in a middle region than at end regions at which the expansion-and-locking arms are hingedly attached to the fingers.

14. The process according to claim 12, wherein the unexpanded, mechanically-expandable foam sheet comprises expansion-and-locking arms of substantially uniform width.

15. The process according to claim 12, wherein each cavity well has a centrally-positioned finger therein.

16. The process according to claim 1, wherein the mechanically-expanded foam sheet comprises at least one member selected from polyolefin, polyurethane, rubber, silicone resin, ethylene/unsaturated acrylate copolymer, ethylene/acrylic acid copolymer, ethylene/methacrylic acid copolymer, ionomer resin, styrene/butadiene copolymer, styrene/butadiene/styrene random and block copolymer, styrene/isoprene/styrene random and block copolymer, and styrene/ethylene/butylene copolymer.

17. The process according to claim 1, wherein the mechanically-expanded foam sheet comprises at least one member selected from ethylene homopolymer, ethylene/alpha-olefin copolymer, propylene homopolymer, propylene/alpha-olefin copolymer, ethylene/methyl acrylate copolymer, ethylene/ethyl acrylate copolymer, ethylene/butyl acrylate copolymer, and polyurethane.

18. The process according to claim 1, wherein the mechanically-expanded foam sheet exhibits a percent free volume of from 40 percent to 70 percent.

19. The process according to claim 1, wherein the foam sheet has a density of from 0.5 to 2 pounds per cubic foot while the foam sheet is in a mechanically unexpanded configuration, and the foam sheet has a thickness of from 0.25 inch to 1.5 inches.

20. The process according to claim 1, wherein the foam sheet has a density of from 1 to 1.5 pounds per cubic foot while the foam sheet is in a mechanically unexpanded configuration, and the foam sheet has a thickness of from 0.25 inch to 1 inch.

21. The process according to claim 1, wherein the foam sheet has a density of from 1.1 to 1.3 pounds per cubic foot while the foam sheet is in a mechanically unexpanded configuration, and the foam sheet has a thickness of from 0.5 to 0.75 inch.

22. The process according to claim 1, wherein the expanded foam sheet is laminated to a non-expandable foam sheet or film.

23. The process according to claim 1, wherein the expanded sheet of foam is laminated to at least one additional expanded sheet of foam.

24. The process according to claim 1, wherein a length of sheet of expanded foam is laid on an oil-and-water mixture and a vessel continuously takes in the sheet of expanded foam after it has absorbed oil, with the vessel having a mechanism to continuously remove oil from the oil-laden sheet of expanded foam by squeezing the oil-laden sheet of expanded foam, with the vessel also continuously re-deploying the sheet of expanded foam after oil has been squeezed out of the oil-laden sheet of expanded foam.
